(19) United States
(12) Patent Application Publication
(10) Pub. No.: US 2005/0226503 A1
(43) Pub. Date: Oct. 13, 2005

(54) Scanned image content analysis

(76) Inventors: James R. Bailey, Shelbyville, KY (US); John B. Bates, Harrodsburg, KY (US); Joseph K. Yackzan, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/819,540

(22) Filed: Apr. 7, 2004

(51) Int. Cl. G06K 9/34; G06K 9/48

(52) U.S. Cl. 382/173; 382/199

(57) ABSTRACT

Scanned image content is analyzed by identifying and quantifying each of a number of pixel categories in sub-regions of a rectangular grid defined over the scanned-in image data. The counts or other quantities are compared with predetermined pixel distributions, and the sub-regions are characterized in response to the comparison. An image processing operation that depends upon the characterization can then be performed.

### CROSS REFERENCES TO RELATED APPLICATIONS

This application is related to U.S. patent Ser. No. 10/754,123 filed Jan. 9, 2004, entitled “METHOD AND APPARATUS FOR AUTOMATIC SCANNER DEFECT DETECTION” and assigned to the assignee of the current application.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to image processing and, more specifically, to analyzing the content of a scanned image.

2. Description of the Related Art

A scanner is a computer peripheral device or portion of a multifunction or “all-in-one” machine (e.g., scanner/printer/copier/fax) that digitizes a document placed in it. The resulting image data can then be provided to a computer or otherwise processed, printed, faxed, or e-mailed. Scanners are known that analyze the content of the image data to facilitate operations such as detecting where the image is on the scanner glass and using that information to perform operations such as that known as “auto-fit” or “fit-to-page,” and optimizing printing settings that may depend upon the content of the document (e.g., text, photograph, business graphics, mixed, etc.) or the document medium (e.g., glossy/reflective paper, transparency, film, or plain paper).

Scanners that have been incorporated into multifunction machines typically perform a copy operation by repeating the steps, in a pipelined fashion, of scanning part of the image, storing it in memory, processing the stored image portion, then printing the processed portion from memory. This pipelining method is used to minimize memory requirements and to perform scanning and printing in parallel to the greatest extent possible. In such multifunction machines, for reasons of economy, there is typically neither a great amount of memory nor a great amount of processing power. Image pipeline processing is typically controlled by essentially a single chip, such as an application-specific integrated circuit (ASIC). The image portion that is scanned, stored and processed may be a band comprising a number (“N”) of scan lines. In other words, the image is broken up into a number of bands, each comprising N scan lines. In FIG. 1, an image, represented by the shaded or crosshatched area, is shown overlaid with bands.

The image processing that has been performed on a band-by-band basis in certain multifunction machines consisted of detecting and counting the number of black pixels, white pixels and color pixels in each band, creating a histogram, and making a decision based upon the histogram as to whether the image is most appropriately classified as text, picture, or graphics. Then, based on the classification of the image, printer settings can be adjusted accordingly.

It would be desirable to provide an image analysis method and system for multifunction machines that facilitates performing a broader variety of operations than is possible with conventional processing and yet does not require an excessive amount of memory or processing power in the image pipeline ASIC or other chip. The present invention addresses this need and others in the manner described below.

### SUMMARY

The present invention relates to a method and system for analyzing scanned image content. In some embodiments of the invention, the system can be included in an application-specific integrated circuit (ASIC) or other integrated circuit chip. The image data is received from a scanner or other scanning device, such as the scanning subsystem of a multifunction (e.g., scanner/printer/copier) machine. A generally rectangular grid of sub-regions is defined over the pixels of the image data. In each sub-region or, alternatively, a pixel group comprising a plurality of adjacent sub-regions, the number of pixels within each of a number of pixel categories is counted or otherwise quantified. For example, the categories may be black pixels, white pixels, gray pixels and color pixels, or some suitable combination of two or more of these.

The count or, equivalently, a value derived from a count or from which a count is derivable, such as a percentage, is compared with a predetermined pixel distribution. The distribution may be, for example, a threshold percentage of black pixels, a threshold percentage of white pixels, a threshold percentage of gray pixels, and a threshold percentage of color pixels, or some suitable combination of two or more of these. In response to this comparison with the predetermined pixel distribution, the sub-region or the pixel group is characterized as being of one of a plurality of types. For example, the types may include whitespace, non-whitespace, text, graphics and so forth.

An image processing operation is then performed in response to the characterization. For example, if whitespace is found bordering a central area of text or graphics, the image processing operation can include automatically fitting the central area to page-size or detecting a margin. Similarly, for example, if one area of a document is characterized as text and another area is characterized as graphics, image-enhancement parameters can be selected for the text area that are optimal for text, while other image-enhancement parameters can be selected for the graphics area that are optimal for graphics. In addition to or alternatively to these exemplary operations, any other suitable operation of the types commonly performed in scanner systems or multifunction machines can be performed.

Additional embodiments and advantages of the invention will be set forth in part in the description that follows, and in part will be obvious from the description herein, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 illustrates a scanned image overlaid on horizontal bands;

FIG. 2 illustrates a scanned image overlaid onto a grid, with an enlarged area showing exemplary counts of different types of pixels in some of the grid regions;

FIG. 3 is a block diagram of a system for analyzing scanned image content;

FIG. 4 is a flow diagram of a method for analyzing scanned image content;

FIG. 5 is a flow diagram of a method for counting pixels of different types or categories;

FIG. 6 is a flow diagram of an image processing method for detecting a left margin of a scanned image;

FIG. 7 is a flow diagram of an image processing method for detecting a right margin of a scanned image;

FIG. 8 illustrates an image scan;

FIG. 9 illustrates the image scan of FIG. 8 with a grid overlaid;

FIG. 10 illustrates the result of a method for detecting the boundaries of the image scan;

FIG. 11 is a flow diagram of an image processing method for detecting boundaries of a scanned image; and

FIG. 12 is a continuation of the flow diagram of FIG. 11.

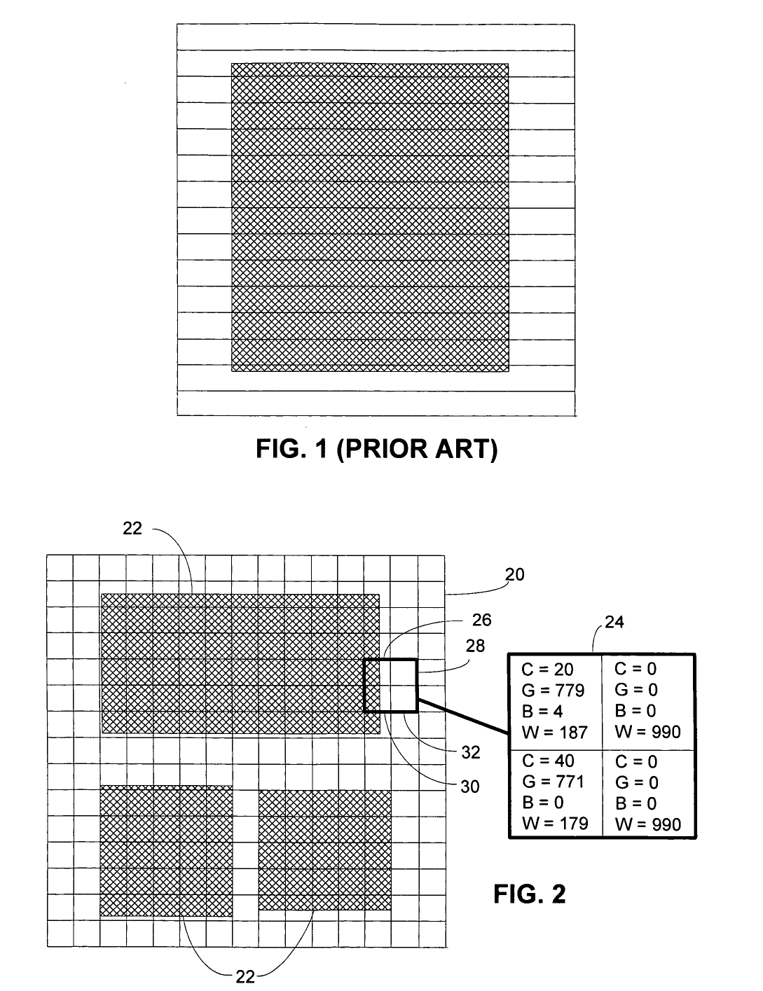

### DETAILED DESCRIPTION

As illustrated in FIG. 2, in an exemplary embodiment of the invention, image data scanned from a document or other source, comprising a region 20 of pixels, has a generally rectangular grid conceptually overlaid upon it. Thus, the grid defines rectangular grid spaces or sub-regions of pixels. Stated another way, the scanned image data is divided into rectangular sub-regions containing an array of pixels. Typically, scanned image data comprises regions of white or mostly white pixels bordering one or more regions of text, graphics or other content, indicated in FIG. 2 by the shaded content region 22. These bordering regions generally represent the margins of the scanned document. The inset 24 illustrates the content within an exemplary four mutually adjacent spaces or sub-regions 26, 28, 30 and 32. In the illustrated example, sub-region 26 consists of the following quantities or counts of pixels of the following types or categories: 20 color (“C”) pixels, 779 gray (“G”) pixels, four black (“B”) pixels, and 187 white (“W”) pixels. Similarly, sub-region 28 consists of: zero color pixels, zero gray pixels, zero black pixels and 990 white pixels. Note that it can be inferred that the image has a margin bordering on sub-regions 28 and 32 because the number of non-white pixels in sub-regions 26 and 30 are sharply greater than the number of non-white pixels in adjacent sub-regions 28 and 32, respectively. The significance of such an inference is described in further detail below.

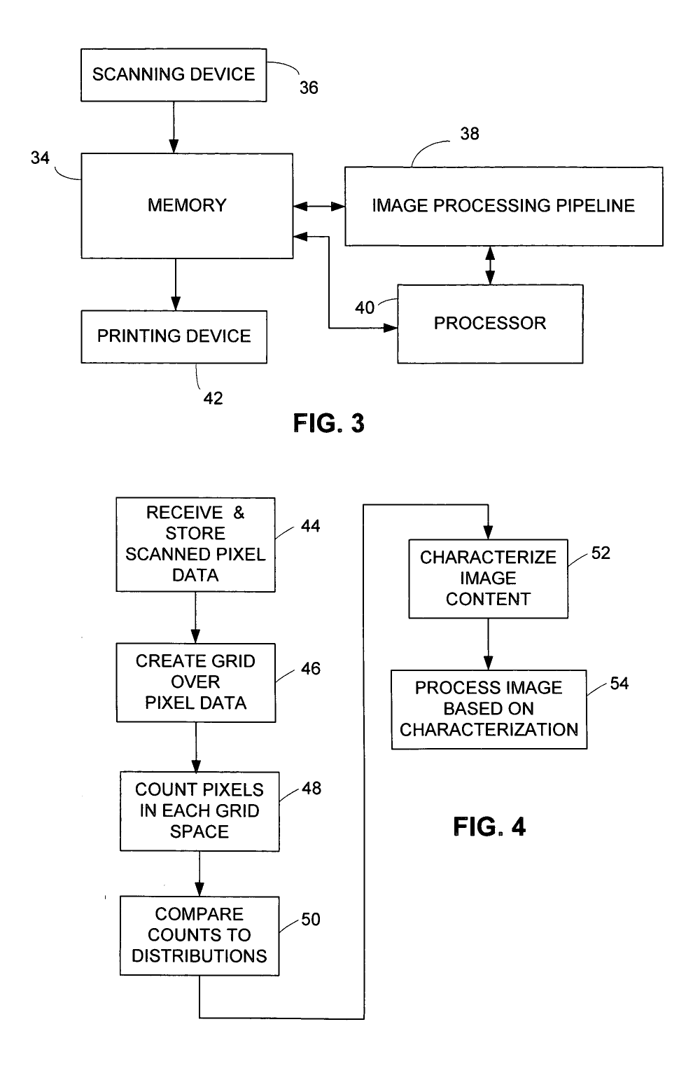

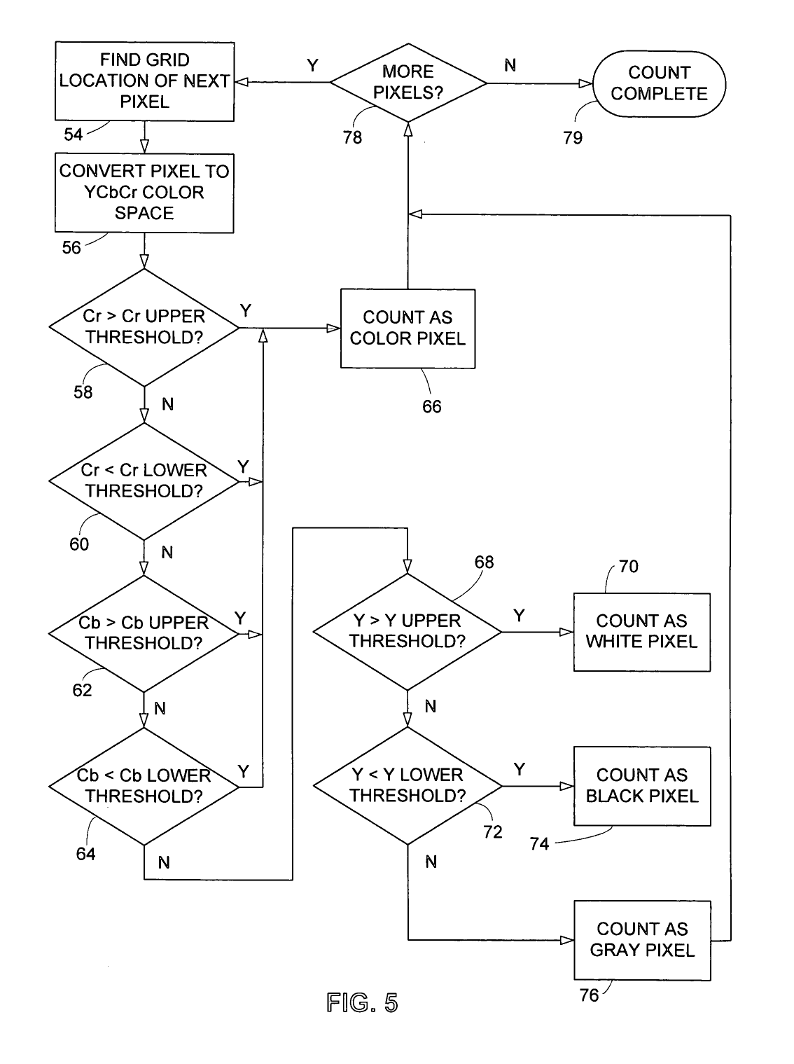

As illustrated in FIG. 3, an apparatus or system for analyzing scanned image content comprises a memory 34 and associated means for receiving image data from a scanning device, such as the scanner portion 36 of a multi-function or all-in-one machine, and means for controlling the system and performing image processing operations, such as the combination of an image processing pipeline 38 and a processor 40. Image processing pipeline 38 can be included in an application-specific integrated circuit (ASIC) or other integrated circuit chip or chipset. Persons skilled in the art to which the invention pertains will, in view of the description below of the process or method illustrated in FIG. 4, understand that processor 40 executes program code in software or firmware that enables it to manipulate the data in memory 34, define the rectangular grid of sub-regions over the pixels stored in memory 34, and effect the counting, comparing, image characterization and other method steps described below with regard to FIG. 4. In view of the description below, such persons will readily be capable of providing and configuring a suitable system of hardware, software, firmware or some combination thereof that effects such steps. Ultimately, processor 40 can cause the processed image resulting from such a method to be output from the image processing pipeline 38 to memory 34 or to a printing device 42, such as the printer portion of a multi-function machine, or other output device. It should be understood that the arrangement or architecture of the system illustrated in FIG. 3, as well as the sequence of method steps illustrated in FIG. 4, are exemplary, and others will occur readily to persons skilled in the art in view of the teachings in this patent specification. In other embodiments, the system can have more or fewer elements, and the method can have more or fewer steps. Furthermore, it should be understood that the functions of elements can be separated, combined, or otherwise distributed over a group of elements in a manner different from that described in this exemplary embodiment of the invention.

As illustrated in FIG. 4, in an exemplary embodiment of the invention, the method for analyzing scanned image content comprises the steps 44, 46, 48, 50 and 52, which can effected by processor 40 in conjunction with the other elements of the exemplary system illustrated in FIG. 3. At step 44, pixel data is received from a scanning device such as device 36 (FIG. 3) and stored in memory 34. This pixel data comprises a region of pixels, as illustrated in FIG. 2. At step 46, a grid of generally rectangular sub-regions is conceptually defined over the entire region of pixels of the scanned image data. Each generally rectangular sub-region comprises an n by m (n×m) array of pixels of the image data. The creation of the grid and sizing of the sub-region arrays can be done by any of a number of memory addressing or indexing schemes that will occur readily to persons skilled in the art. Preferably, the sub-region arrays are of equal size but arrays of varying sizes may also be used with the present invention.

At step 48, the number of pixels of each of a number of pixel categories within each sub-region is counted. For example, in some embodiments of the invention, there can be the following four categories or a subset thereof: color pixels, gray pixels, black pixels and white pixels. In an embodiment in which these four categories are counted, in each sub-region, the number of color pixels is counted, the number of gray pixels is counted, the number of black pixels is counted, and the number of white pixels is counted. In some embodiments, the categories can include white pixels and non-white pixels. Black pixels, gray pixels and color pixels are examples of non-white pixels. These teachings and examples will lead persons skilled in the art to consider still other pixel categories that may be useful in other embodiments of the invention.

At step 50, the pixel counts are compared to one or more pixel distributions. A pixel distribution characterizes a group of one or more sub-regions as having the characteristics of a certain type of content, such as whitespace, text, graphics, non-whitespace (i.e., text, graphics—anything but whitespace), etc. The term “graphics” includes photographic images, business graphics, drawings, clip art and other similar images For example, referring to FIG. 2, the existence of a sub-region or group of several adjacent sub-regions in which the great majority of pixels are white is characteristic of a margin area of a document or other whitespace. Thus, a corresponding distribution can be defined in which the number or, equivalently, percentage of white pixels exceeds some predetermined threshold value. Detecting the type of content a document contains and its location on the document is an important objective and can, as described in further detail below, provide a basis for performing further image processing operations tailored to the content type. For example, it is desirable to detect where on the document image the left and right margins are located. As another example, it may be desirable to detect where on the document image a region of text borders a region of graphics, or where a region of whitespace bordering regions of text indicates a gap between columns of text. It will be apparent to persons skilled in the art that much can be inferred by knowing the locations of various types of content on a document image. The present invention facilitates such inferences and the performance of image processing operations that are based upon what is inferred.

The pixel distribution can be empirically determined, defined mathematically or algorithmically in any suitable manner. The term “distribution” is used for convenience in this patent specification and is not intended to imply any specific mathematical or algorithmic concept. In the illustrated embodiment, a distribution can be defined by a set of upper and lower threshold values against which the counts or percentages of pixels in the various categories are compared.

At step 52, the group of one or more sub-regions is characterized as representing one of several types of content. As indicated above, the characterization is made based upon or in response to the comparison of the counts or percentages of pixels in each category with the distribution or distributions. Thus, for example, if the counts or percentages fit a distribution associated with whitespace, the group is characterized as whitespace.

At step 54, an image processing operation is performed in response to the characterization. In other words, the image processing operation is one that depends upon or uses as one of its inputs the type of content. For example, margin detection is one well-known image processing operation performed in multi-function machines. In margin detection, only the printable region or region containing information is stored in memory and further processed or printed in order to minimize memory requirements and improve performance. In other words, only the image data bounded by the margins (whitespace) is processed. Margin detection is described in further detail below.

Another well-known image processing operation performed in multi-function machines is known as “auto-fit.” Auto-fit scales the image to fit the entire printed output page. As one step in the auto-fit process, a rectangular border that bounds the printable region is defined. The area defined by the border is then subjected to auto-fit or other processes. Still other image processing operations can include processing text differently from graphics. It would be desirable, for example, to use a different color print table for text than graphics, or to apply different filters to text and graphics regions, or to apply a background removal operation to the text portion and not the graphics portions. All such image processing operations depend upon identifying regions representing such content types and their locations within the scanned image data.

The step of counting pixels of the various categories in each sub-region is illustrated in further detail in FIG. 5. Pixels are processed in any suitable sequence, such as a raster-scan sequence. At step 54, the next pixel in the sequence is processed by determining the grid space, also referred to herein as a sub-region, in which the pixel is located. If the value of the pixel is stored in RGB or some color space format other than YCrCb, it is converted to YCrCb color space at step 56. The formula for performing this conversion is described in a well-known international standard, ITU-R BT.601 (formerly CCIR 601). In other embodiments of the invention, the following steps can be performed in other color spaces, and conversion may not be necessary. At step 58, it is determined whether the chrominance-red (Cr) value of the pixel is greater than some predetermined upper threshold value. If it is not, then at step 60 it is it is determined whether the Cr value of the pixel is less than or equal to some predetermined lower threshold value. If it is not, then at step 62 it is determined whether the chrominance-blue (Cb) value of the pixel is greater than some predetermined upper threshold value. If it is not, then at step 64 it is determined whether the Cb value of the pixel is less than some predetermined lower threshold value. If any of these are true, then the pixel is counted as a color pixel at step 66 and not as gray, black or white. If none of these are true, then at step 68 it is determined whether the luminance (Y) value of the pixel is greater than some predetermined upper threshold. If it is, then it is counted as a white pixel at step 70. If it is not, then at step 72 it is determined whether the Y value of the pixel is less than some predetermined lower threshold value. If it is, then it is counted as a black pixel at step 74. If it is not, then it is counted as a gray pixel at step 76. After the pixel is counted, then at step 78 it is determined whether there are more pixels in the sequence to process. If there are, the process continues with the next pixel at step 54. Otherwise, the process of counting the pixels in each category is completed at step 79. When completed, each sub-region has a corresponding count of the number of pixels in each category, i.e., black, white, gray and color.

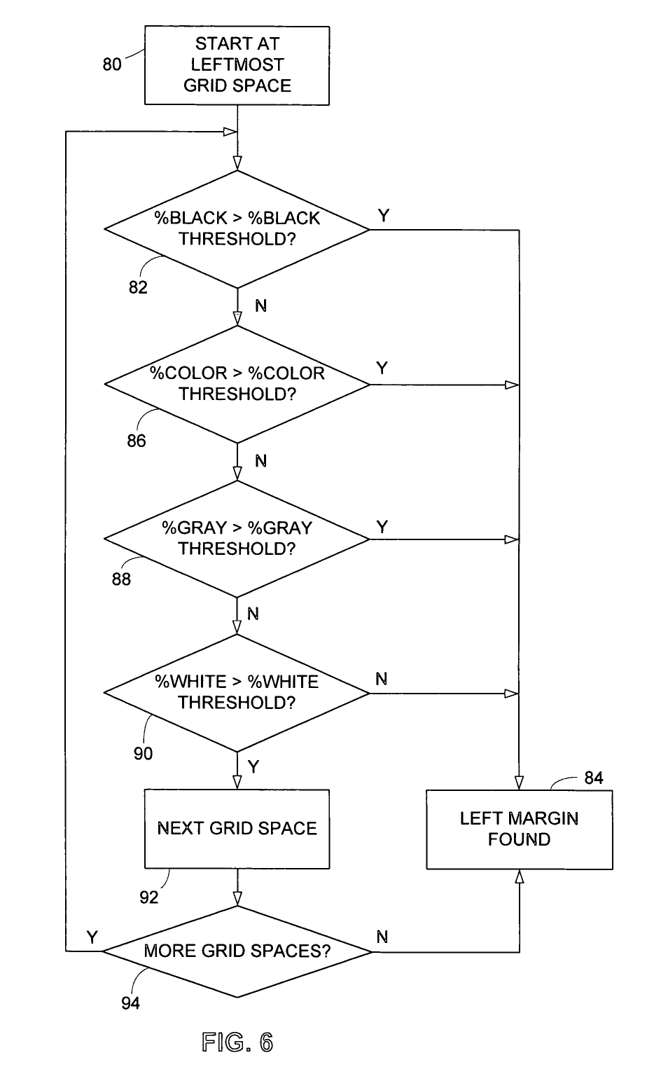

As described above with regard to the method illustrated in FIG. 4, a group of one or more sub-regions is characterized in response to comparison of the corresponding counts with a predetermined pixel distribution. An image processing operation can then be performed in response to the characterization. For example, FIG. 6 illustrates a method in which the image processing operation includes detecting the left margin of the document image. The method operates on one band or horizontally arrayed group of sub-regions and can be repeated for additional bands. At step 80 the method begins at the leftmost grid space or sub-region and proceeds to the right until the left margin is found or the rightmost sub-region is reached. At step 82, it is determined whether the percentage of black pixels in that sub-region (i.e., the number of black pixels divided by the total number of pixels) is greater than some predetermined threshold value. The margin is assumed to be white or mostly white. Therefore, if the percentage is greater, the left margin has been found, as indicated by step 84. If the percentage is not greater, then at step 86 it is determined whether the percentage of color pixels in that sub-region is greater than some predetermined threshold. If the percentage of color pixels is greater, the left margin has been found, as indicated by step 84. Similarly, if it is not greater, then at step 88 it is determined whether the percentage of gray pixels in that sub-region is greater than some predetermined threshold. If the percentage of gray pixels is greater, the left margin has been found, as indicated by step 84. If it is not greater, then at step 90 it is determined whether the percentage of white pixels in that sub-region is greater than some predetermined threshold. If the percentage is greater, then the left margin has not been found and, as indicated by step 92, the process continues with the next leftmost sub-region until at step 94 it is determined that there are no more sub-regions, i.e., the rightmost sub-region has been processed. If the percentage of white pixels is not greater than the predetermined threshold percentage, or if no more sub-regions exist in the band, then the left margin has been found, as indicated by step 84. Selecting suitable threshold percentages is well-within the capabilities of the person of skill in the art, but by way of example, in some embodiments of the invention, a sub-region can be characterized as margin or whitespace if it has more than 99% white pixels because the remaining one percent of non-white pixels is sufficiently small to be considered noise and would be removed or eliminated in subsequent processing of the white space.

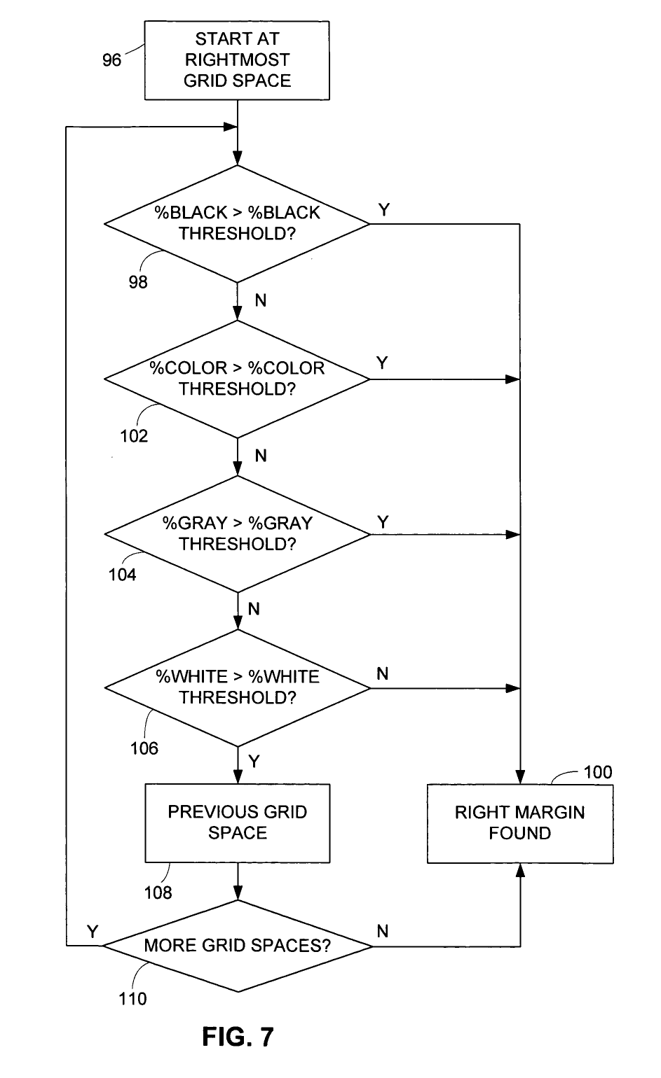

As illustrated in FIG. 7, essentially the same method can be used for detecting the right margin of a document image, except that the method begins at step 96 at the rightmost sub-region of a band and proceeds to the left until either the right margin is found or the leftmost sub-region is reached. Steps 98, 100, 102, 104, 106, 108 and 110 correspond to steps 82, 84, 86, 88, 90, 92 and 94, respectively. Some embodiments of the invention can include steps for detecting both left and right margins. Still other embodiments can detect top and bottom margins in a similar manner.

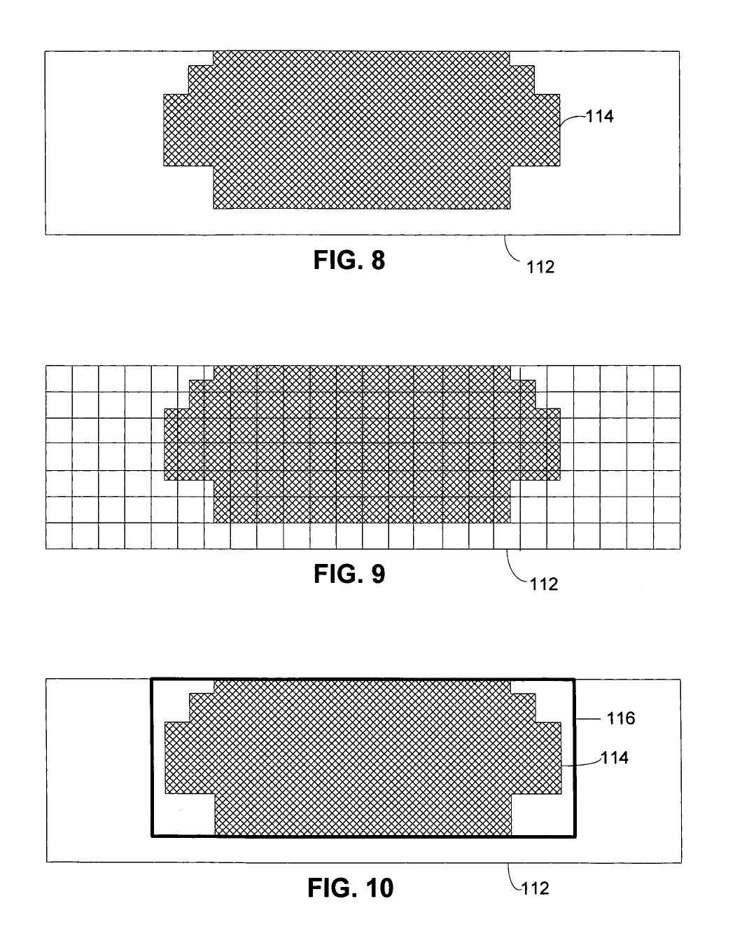

As illustrated in FIG. 8, it may be desirable to perform an auto-fit image processing operation on a scanned document image 112 that has a printable (i.e., non-margin) area 114 with an irregular shape. As illustrated in FIG. 10, to perform auto-fit (and certain other well-known operations in multi-function machines and similar devices), a rectangular area 116 bounding printable area 114 must be identified. The machine can pre-scan the document first in a fast, lower-resolution mode to identify rectangular area 116, then scan again in normal resolution to obtain the image data. Such a pre-scan can also be used with the margin-detection methods described above with regard to FIGS. 6 and 7. Note that rectangular area 116 comprises a group of the sub-regions indicated by the grid shown in FIG. 9.

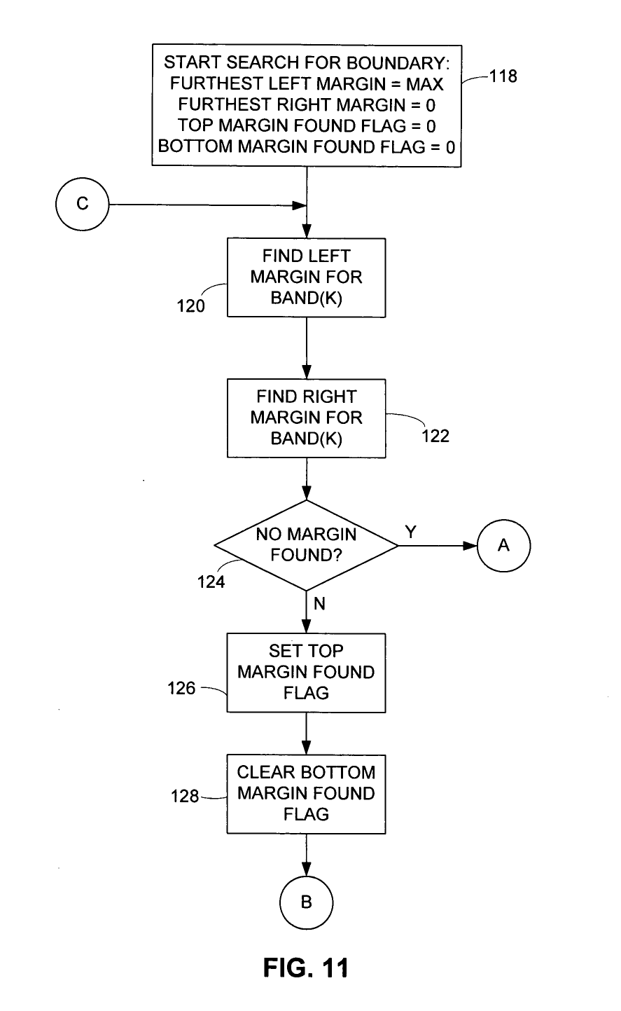

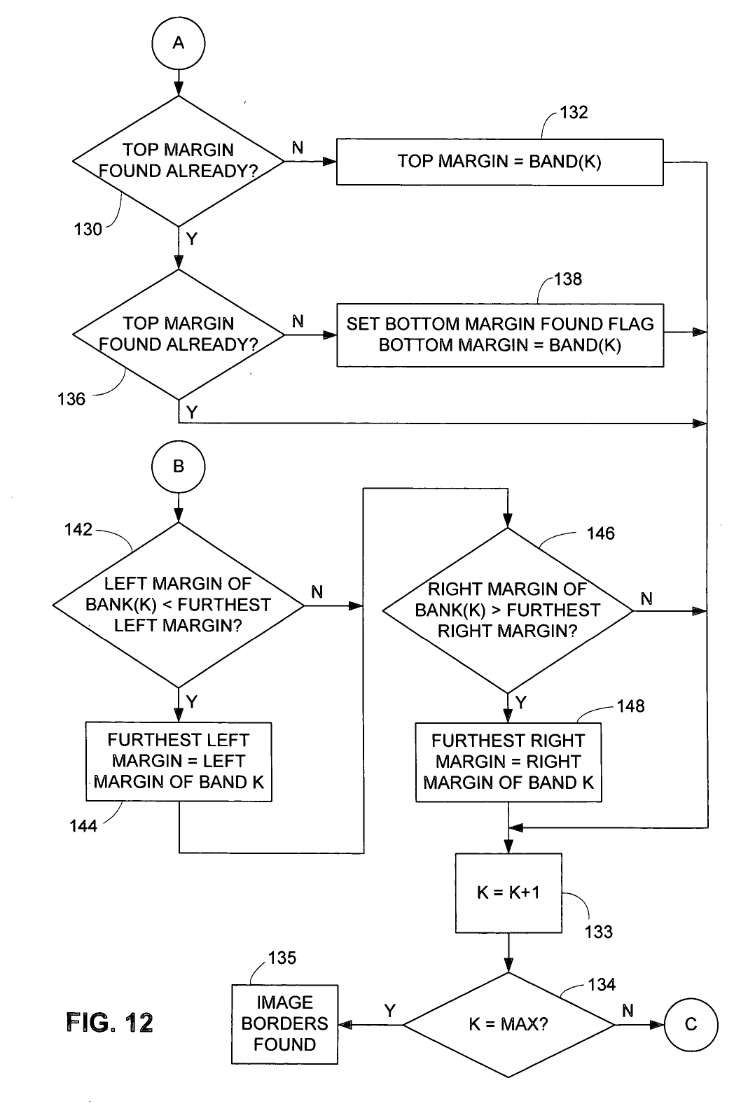

A method for identifying a rectangular border around the printable area of a scanned document is illustrated in FIG. 11. The method begins at step 118 by initializing values for the furthest left and right margins found and flags that indicate whether the top and bottom margins have been found. The method begins at the topmost band of sub-regions and proceeds band-by-band toward the bottom of the document image. In FIGS. 11 and 12, the band then being processed (the current band) is referred to as band K.

At steps 120 and 122, respectively, the left and right margins of a band of sub-regions are identified as described above with regard to FIGS. 6 and 7. If it is determined at step 124 that a margin has been found, then at step 126 a flag is set that indicates the top margin has been found, and at step 128 a flag is cleared that indicates the bottom margin has not been found. The use of these two flags allows the top margin to be found while avoiding a premature determination of the band containing the bottom margin. This allows for situations such as shown in FIG. 2 where there is image data separated by a band of horizontal white space as you progress through the bands. Because the processing of the bands proceeds from the top to the bottom, once the top margin is found the top margin flag found is set and remains set throughout the processing of the remaining bands. The determination of bottom margin can be done before determining the top margin and is dependent on the order of processing chosen for the bands.

The process then continues at step 142 (FIG. 12). If it is determined at step 124 that no margin has yet been found, the process continues at step 130. If it is determined at step 130 that the top margin has not been found, then at step 132 a value is set to indicate that the top margin is the current band (band K). Following step 132, the process continues at step 133, where K is incremented (i.e., the process continues with the next band).

If it is determined at step 130 that the top margin has already been found, then at step 136 it is determined whether the bottom margin has already been found. If both the top and bottom margins have been found, the process continues at step 133. If the top margin has been found but the bottom margin has not been found, then at step 138 a flag is set that indicates the bottom margin has been found and is located in the current band (band K). Following step 138, the process continues at step 133.

At step 134, it is determined whether the last (bottom-most) band has been processed. If it has, this implies that all image borders have been found at block 135, and the process is completed. If it has not, the process returns to steps 120 and 122 to continue with the next band.

As noted above, steps 142 and 146 are performed following step 128. At step 142, it is determined whether the left margin of band K is less than (i.e., to the left of, with respect to the orientation of the document image) the furthest left margin. The furthest left margin is a value that indicates, of all bands, the margin that has thus far in the process been found to be closest to the left edge of the document image. If the left margin of band K is not less than the furthest left margin, the process continues at step 146. If the left margin of band K is less than the furthest left margin, then at step 144 the value for the furthest left margin is set to the value of the left margin of the current band (band K). The process then continues at step 146. At step 146, it is determined whether the right margin of band K is greater than (i.e., to the right of, with respect to the orientation of the document image) the furthest right margin. The furthest right margin is a value that indicates, of all bands, the margin that thus far in the process has been found to be closest to the right edge of the document image. If the right margin of band K is not greater than the furthest right margin, the process continues at step 133, where K is incremented. If the right margin of band K is greater than the furthest right margin, then at step 148 the value for the furthest right margin is set to the value of the right margin of the current band (band K). The process then continues at step 133. Determining the right and left margins of the current bank K and determining whether or not the current band K left and right margins are furthest left or right can be reversed or done in parallel.

As described above, following step 133 it is determined whether the last band has been processed at step 134 and thus whether the process is completed or the next band is to be processed.

In the manner described above with regard to FIGS. 6, 7, 11 and 12, borders between whitespace and non-whitespace in a scanned document image can be detected and used for margin-detection, auto-fit and other image processing operations.

In addition to margin-detection and auto-fit, there are many other image processing operations that can be performed once sub-region groups have been characterized as being of certain types. For example, the machine can process text regions differently from graphics regions. Text regions will typically have a certain percentage range of white pixels plus a certain percentage range of pixels that are either black or gray. Graphics regions will typically have a certain percentage range of non-white pixels that include a certain percentage range of pixels that are either color or gray. For example, text may be 40%-70% white, 30%-60% gray or black, and 0%-2% color. Similarly, for example, graphics may be less than 10% white or, alternatively, be more than 20% color. Persons skilled in the art are familiar with such characteristics of text, graphics, pictures and other content types and will readily be capable of defining such pixel distributions against which the counts or percentages can be compared to infer content type.

It can be appreciated that by analyzing groups of one or more sub-regions, it can be inferred that, for example, the document image includes a text region separated from a graphics region by a horizontal or vertical line. For example, if a group of sub-regions in a band have less than 5% color pixels, and an adjacent group of sub-regions in the band has more than 5% color pixels, it can be inferred that one group is text and the other graphics. Similarly, if a group of sub-regions having a very low percentage of white pixels is adjacent a group of sub-regions having more white pixels, it can be inferred that the group with fewer white pixels is graphics. The machine can then optimize processing of such an image accordingly. For example, it can use a different color print table for the text and graphics regions, or apply a background removal process to the text region but not the graphics region.

The methods of the present invention can also be used to aid compensating for localized noise in the image scan. It is known that a scanner may inherently have, for example, noise that results in streaks in the displayed or printed document image. By scanning the (white) cover of a flatbed scanner and counting the color and gray pixels in each sub-region as described above, information can be obtained that describes whether any part of the scan field is inherently noisier than another. The information can then be used in margin-detection, auto-fit and text/graphics detection to treat the noisy areas differently than other areas so as to compensate for the noise. For example, it may be determined that 3% of the pixels in the first three sub-regions in a certain band of the scan field are merely noise, but only 1% of the pixels in the remaining sub-regions of that band are either color or gray. Therefore, a subsequent image processing operation performed upon the first three sub-regions can reduce each of the predetermined thresholds that define the distributions (see FIGS. 6 and 7) by 3% to compensate for the noise in those sub-regions, and a subsequent image processing operation performed upon any of the remaining sub-regions can reduce each of the predetermined thresholds that define the distributions by 1% to compensate for the noise in those sub-regions.

In the manner described above, scanned image content can be analyzed by identifying and quantifying each of a number of pixel categories, such as black, white, gray, color, non-white, etc., in sub-regions of a rectangular grid defined over the scanned-in image data. The counts or quantities derived from the counts (e.g., percentages) are compared with predetermined pixel distributions, and the sub-regions are characterized in response to the comparison. Subsequent image processing operations can then be optimized for the content type or types or to compensate for detected noise.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for analyzing scanned image content, comprising the steps of:
receiving image data from a scanning device, the image data comprising a region of pixels;
defining a generally rectangular grid of generally rectangular sub-regions of pixels over the region of pixels of the image data;
in each sub-region, quantifying pixels in at least one of a plurality of pixel categories;
in a pixel group comprising one or more adjacent sub-regions, comparing a quantification of pixels of each pixel category with a predetermined pixel distribution;
in response to comparison of the quantification of pixels of each pixel category with a predetermined pixel distribution, characterizing the pixel group as being of one of a plurality of types; and
performing an image processing operation in response to characterization of the pixel group.

2. The method claimed in claim 1, wherein the plurality of pixel categories comprises at least two pixel categories selected from the group consisting of: black pixels, white pixels, gray pixels, and color pixels.

3. The method claimed in claim 1, wherein the plurality of types of pixel groups comprises at least two types selected from the group consisting of: whitespace, non-whitespace, text, and graphics.

4. The method claimed in claim 1, wherein:
the step of quantifying pixels in at least one of a plurality of pixel categories comprises counting black pixels, counting white pixels, counting color pixels and counting gray pixels;
the step of comparing a quantification of pixels of each pixel category to a predetermined pixel distribution comprises comparing a count of black pixels in a sub-region with a predetermined black pixel threshold percentage, comparing a count of white pixels in the sub-region with a predetermined white pixel threshold percentage, comparing a count of color pixels in the sub-region with a predetermined color pixel threshold percentage, and comparing a count of gray pixels in the sub-region with a predetermined gray pixel threshold percentage; and
the step of characterizing the pixel group as being of one of a plurality of types comprises characterizing the pixel group as being whitespace or non-whitespace.

5. The method claimed in claim 4, wherein the step of performing an image processing operation comprises processing image data bounded by a margin identified in response to whether each of a plurality of pixel groups is characterized as whitespace or non-whitespace.

6. The method claimed in claim 4, wherein the step of performing an image processing operation comprises processing image data bounded by a rectangular area identified in response to whether each of a plurality of pixel groups is characterized as whitespace or non-whitespace.

7. The method claimed in claim 1, wherein:
the step of quantifying pixels in at least one of a plurality of pixel categories comprises counting black pixels, counting white pixels, counting color pixels and counting gray pixels;
the step of comparing a quantification of pixels of each pixel category to a predetermined pixel distribution comprises comparing a count of black pixels in a sub-region with a predetermined black pixel range, comparing a count of white pixels in the sub-region with a predetermined white pixel range, comparing a count of color pixels in the sub-region with a predetermined color pixel range, and comparing a count of gray pixels in the sub-region with a predetermined gray pixel range;
the step of characterizing the pixel group as being of one of a plurality of types comprises characterizing the pixel group as text or graphics; and
the step of performing an image processing operation comprises processing pixel groups characterized as text differently from pixel groups characterized as graphics.

8. A method for detecting a border between whitespace and non-whitespace in a document in response to scanned image content, comprising the steps of:
receiving image data from a scanning device, the image data comprising a rectangular region of pixels;
defining a rectangular grid of rectangular sub-regions of pixels over the entire rectangular region of pixels of the image data;
in each sub-region, counting pixels of each of a plurality of pixel categories;
in a pixel group comprising one or more adjacent sub-regions, comparing a count of pixels of each pixel category with a predetermined pixel distribution;
in response to comparison of the count of pixels of each pixel category with a predetermined pixel distribution, characterizing the pixel group as being whitespace or non-whitespace; and
repeating the steps of comparing a count of pixels of each pixel category with a predetermined pixel distribution and characterizing the pixel group as being whitespace or non-whitespace for another pixel group until a transition between a pixel group characterized as being whitespace and a pixel group characterized as being non-whitespace is identified.

9. The method claimed in claim 8, wherein:
the step of comparing a count of pixels of each pixel category to a predetermined pixel distribution comprises comparing a count of black pixels in a sub-region with a predetermined black pixel threshold percentage, comparing a count of white pixels in the sub-region with a predetermined white pixel threshold percentage, comparing a count of color pixels in the sub-region with a predetermined color pixel threshold percentage, and comparing a count of gray pixels in the sub-region with a predetermined gray pixel threshold percentage; and
the step of characterizing the pixel group as being whitespace or non-whitespace comprises characterizing the pixel group as being non-whitespace if the count of black pixels in a sub-region exceeds the predetermined black pixel threshold percentage, the count of color pixels in the sub-region exceeds the predetermined color pixel threshold percentage, the count of gray pixels in the sub-region exceeds the predetermined gray pixel threshold percentage, or the count of white pixels in the sub-region exceeds the predetermined white pixel threshold percentage.

10. The method claimed in claim 8, wherein:
the pixel group consists of no more than one sub-region;
the transition signifies a document left margin; and
the another pixel group is a next pixel group to the right of a pixel group for which a count of pixels of each pixel category was previously compared with a predetermined pixel distribution.

11. The method claimed in claim 10, wherein:
the step of comparing a count of pixels of each pixel category to a predetermined pixel distribution comprises comparing a count of black pixels in a sub-region with a predetermined black pixel threshold percentage, comparing a count of white pixels in the sub-region with a predetermined white pixel threshold percentage, comparing a count of color pixels in the sub-region with a predetermined color pixel threshold percentage, and comparing a count of gray pixels in the sub-region with a predetermined gray pixel threshold percentage; and
the step of characterizing the pixel group as being whitespace or non-whitespace comprises characterizing the pixel group as being non-whitespace if the count of black pixels in a sub-region exceeds the predetermined black pixel threshold percentage, the count of color pixels in the sub-region exceeds the predetermined color pixel threshold percentage, the count of gray pixels in the sub-region exceeds the predetermined gray pixel threshold percentage, or the count of white pixels in the sub-region exceeds the predetermined white pixel threshold percentage.

12. The method claimed in claim 8, wherein:
the pixel group consists of no more than one sub-region;
the transition signifies a document right margin; and
the another pixel group is a next pixel group to the left of a pixel group for which a count of pixels of each pixel category was compared with a predetermined pixel distribution.

13. The method claimed in claim 12, wherein:
the step of comparing a count of pixels of each pixel category to a predetermined pixel distribution comprises comparing a count of black pixels in a sub-region with a predetermined black pixel threshold percentage, comparing a count of white pixels in the sub-region with a predetermined white pixel threshold percentage, comparing a count of color pixels in the sub-region with a predetermined color pixel threshold percentage, and comparing a count of gray pixels in the sub-region with a predetermined gray pixel threshold percentage; and
the step of characterizing the pixel group as being whitespace or non-whitespace comprises characterizing the pixel group as being non-whitespace if the count of black pixels in a sub-region exceeds the predetermined black pixel threshold percentage, the count of color pixels in the sub-region exceeds the predetermined color pixel threshold percentage, or the count of gray pixels in the sub-region exceeds the predetermined gray pixel threshold percentage or the count of white pixels in the sub-region exceeds the predetermined white pixel threshold percentage.

14. A system for analyzing scanned image content, comprising the steps of:
means for receiving image data from a scanning device, the image data comprising a rectangular region of pixels;
means for defining a rectangular grid of rectangular sub-regions of pixels over the entire rectangular region of pixels of the image data;
means for, in each sub-region, counting pixels of each of a plurality of pixel categories;
means for, in a pixel group comprising one or more adjacent sub-regions, comparing a count of pixels of each pixel category with a predetermined pixel distribution;
means for, in response to comparison of the count of pixels of each pixel category with a predetermined pixel distribution, characterizing the pixel group as being of one of a plurality of types; and
means for performing an image processing operation in response to characterization of a plurality of pixel groups.

15. The system claimed in claim 14, wherein the plurality of pixel categories comprises at least two pixel categories selected from the group consisting of: black pixels, white pixels, gray pixels, and color pixels.

16. The system claimed in claim 15, wherein the plurality of types of pixel groups comprises at least two types selected from the group consisting of: whitespace, non-whitespace, text, and graphics.

17. The system claimed in claim 14, wherein:
the means for counting pixels of each of a plurality of pixel categories counts black pixels, white pixels, color pixels and gray pixels;
the means for comparing a count of pixels of each pixel category to a predetermined pixel distribution compares a count of black pixels in a sub-region with a predetermined black pixel threshold percentage, compares a count of white pixels in the sub-region with a predetermined white pixel threshold percentage, compares a count of color pixels in the sub-region with a predetermined color pixel threshold percentage, and compares a count of gray pixels in the sub-region with a predetermined gray pixel threshold percentage;
the means for characterizing the pixel group as being of one of a plurality of types characterizes the pixel group as being whitespace or non-whitespace.

18. The system claimed in claim 17, wherein the image processing operation processes image data bounded by a margin identified in response to whether each of a plurality of pixel groups is characterized as whitespace or non-whitespace.

19. The system claimed in claim 17, wherein the image processing operation processes image data bounded by a rectangular area identified in response to whether each of a plurality of pixel groups is characterized as whitespace or non-whitespace.

20. The system claimed in claim 14, wherein:
the means for counting pixels of each of a plurality of pixel categories counts black pixels, white pixels, color pixels and gray pixels;
the means for comparing a count of pixels of each pixel category to a predetermined pixel distribution compares a count of black pixels in a sub-region with a predetermined black pixel range, compares a count of white pixels in the sub-region with a predetermined white pixel range, compares a count of color pixels in the sub-region with a predetermined color pixel range, and compares a count of gray pixels in the sub-region with a predetermined gray pixel range;
the means for characterizing the pixel group as being of one of a plurality of types characterizes the pixel group as text or graphics; and
the means for performing an image processing operation processes pixel groups characterized as text differently from pixel groups characterized as graphics.

21. The system claimed in claim 14, wherein the system is included in an integrated circuit chip.
